(19) United States
(12) Patent Application Publication
(10) Pub. No.: US 2026/0311371 A1
(43) Pub. Date: Oct. 8, 2026

(54) METHOD AND SYSTEM FOR CORRECTING COLOUR REPRODUCTION IN CAMERA-CAPTURED IMAGES

(71) Applicant: Varjo Technologies Oy, Helsinki (FI)

(72) Inventors: Ari Antti Erik Peuhkurinen, Helsinki (FI); Mikko Ollila, Tampere (FI)

(73) Assignee: Varjo Technologies Oy, Helsinki (FI)

(21) Appl. No.: 19/170,552

(22) Filed: Apr. 4, 2025

(51) Int. Cl. G06T 7/90; G06T 5/50; G06T 5/60; G06T 7/00; G06V 10/56; G06V 10/77; G06V 10/82

(52) U.S. Cl. CPC G06T 7/90; G06T 5/50; G06T 5/60; G06T 7/0002; G06V 10/56; G06T 2207/10024; G06T 2207/20081; G06T 2207/20084; G06T 2207/30168; G06V 10/7715; G06V 10/82

(57) ABSTRACT

A computer-implemented method for correcting colour reproduction in camera-captured images. The method includes: receiving at least two images of a real-world environment, wherein the at least two images are captured by at least one camera using at least two camera settings that are different from each other; analysing image properties indicative of colour reproduction in the at least two images for identifying colour inconsistencies therebetween; generating information indicative of the identified colour inconsistencies; and applying a correction technique on at least one image amongst the at least two images for generating at least one corrected image, based on the generated information indicative of the identified colour inconsistencies.

### TECHNICAL FIELD

The present disclosure relates to computer-implemented methods for correcting colour reproduction in camera-captured images. The present disclosure also relates to systems for correcting colour reproduction in camera-captured images.

### BACKGROUND

Video see-through (VST) technology is widely employed in extended-reality (XR) systems such as augmented-reality (AR) systems, mixed reality (MR) systems, and similar. In such XR systems, users are provided a view of their real-world surroundings through a VST system comprising one or more cameras. Images captured by the one or more cameras are digitally processed and displayed to the user, optionally, along with virtual content overlaid on said images.

However, achieving accurate colour reproduction remains a significant challenge in VST systems. In particular, there is often a noticeable colour difference between visual content as seen by a human eye and as represented in camera-captured images. In other words, real-world colours are often not reproduced authentically in the camera-captured images of VST systems. For example, when capturing illuminated elements through VST systems, colours often appear different (for example, washed out) as compared to direct visual observation. Moreover, when multiple such illuminated elements are present in a same real-world space, synchronisation of such light sources is impractical or impossible. Existing techniques do not adequately address dynamic and complex lighting variations, thereby causing improper colour reproduction.

Inaccurate colour reproduction adversely impacts realism, immersion, user engagement, and can be safety-critical and/or performance-critical in some use cases. The problem of inaccurate colour reproduction is particularly risky when VST systems are employed in AR/MR systems dealing with applications where visual accuracy is paramount. Such applications are defence, healthcare, automotive applications, or similar. As an example, when real-world spaces have user interface elements such as status indicators or display screens, colour accuracy is essential for readability and accurate interpretation of visual information. Misrepresentation of colours can lead to operational errors, reduced situational awareness, safety issues, or user dissatisfaction.

Therefore, in light of the foregoing discussion, there exists a need to overcome the aforementioned drawbacks.

### SUMMARY

The aim of the present disclosure is to provide a computer-implemented method and a system that effectively correct colour reproduction in camera-captured images to achieve high colour fidelity and colour realism in said images in a computationally efficient manner. The aim of the present disclosure is achieved by a computer-implemented method and a system for correcting colour reproduction in camera-captured images as defined in the appended independent claims to which reference is made to. Advantageous features are set out in the appended dependent claims.

Throughout the description and claims of this specification, the words “comprise”, “include”, “have”, and “contain” and variations of these words, for example “comprising” and “comprises”, mean “including but not limited to”, and do not exclude other components, items, integers or steps not explicitly disclosed also to be present. Moreover, the singular encompasses the plural unless the context otherwise requires. In particular, where the indefinite article is used, the specification is to be understood as contemplating plurality as well as singularity, unless the context requires otherwise.

### BRIEF DESCRIPTION OF THE DRAWINGS

FIG. 1 illustrates steps of a computer-implemented method for correcting colour reproduction in camera-captured images, in accordance with an embodiment of the present disclosure;

FIG. 2 is a block diagram of a system for correcting colour reproduction in camera-captured images, in accordance with an embodiment of the present disclosure;

FIG. 3 is an exemplary schematic illustration of a real-world environment where a system for correcting colour reproduction in camera-captured images is used, in accordance with an embodiment of the present disclosure; and

FIG. 4 is an exemplary illustration of how a correction technique is applied for correcting colour reproduction, in accordance with an embodiment of the present disclosure.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognise that other embodiments for carrying out or practising the present disclosure are also possible.

In a first aspect, the present disclosure provides a computer-implemented method for correcting colour reproduction in camera-captured images, the method comprising:
receiving at least two images of a real-world environment, wherein the at least two images are captured by at least one camera using at least two camera settings that are different from each other;
analysing image properties indicative of colour reproduction in the at least two images for identifying colour inconsistencies therebetween;
generating information indicative of the identified colour inconsistencies; and
applying a correction technique on at least one image amongst the at least two images for generating at least one corrected image, based on the generated information indicative of the identified colour inconsistencies.

In a second aspect, the present disclosure provides a system for correcting colour reproduction in camera-captured images, the system comprising at least one processor configured to:
receive at least two images of a real-world environment from at least one camera, wherein the at least two images are captured by the at least one camera using at least two camera settings that are different from each other, the at least one camera being communicably coupled to the at least one processor;
analyse image properties indicative of colour reproduction in the at least two images to identify colour inconsistencies therebetween;
generate information indicative of the identified colour inconsistencies; and
apply a correction technique on at least one image amongst the at least two images to generate at least one corrected image, based on the generated information indicative of the identified colour inconsistencies.

In a third aspect, the present disclosure provides a computer program product comprising a non-transitory machine-readable data storage medium having stored thereon program instructions that, when executed by at least one processor, cause the at least one processor to implement steps of the computer-implemented method of the first aspect.

The present disclosure provides the aforementioned computer-implemented method, the aforementioned system, and the aforementioned computer program product for correcting colour reproduction in camera-captured images. By leveraging the at least two images captured under different camera settings, the method enables an accurate identification of the colour inconsistencies that are introduced due to limitations of the at least one camera and lighting conditions in the real-world environment. Analysing the image properties (which are extracted from the at least two images) across the at least two images enables the accuracy of said identification. In particular, the image properties may be analysed in a pixel-wise or region-wise manner across the at least two images, for an accurate determination of where and how colours deviate from their true representations, in the at least two images. The information indicative of the identified colour inconsistencies beneficially facilitates a correct determination of the correction technique to be applied, for implementing precise colour correction in the at least one image so that the at least one corrected image has high colour fidelity and colour realism. Colour correction is beneficially performed only for those image(s) that actually require said correction, to save computational efficiency. The method and system enable improved colour reproduction accuracy in video see-through (VST) systems comprising the at least one camera, ensuring that the colours in the at least one corrected image closely match real-world colours. The method and the system can thus be reliably employed in VST systems to generate images with accurate colour reproduction in environments with dynamic lighting conditions or environments with one or more light-emitting elements. Furthermore, the method and the system are easy to implement, and beneficially enable VST systems to be used for applications where visual accuracy is paramount, such as defence, healthcare, automotive applications, or similar.

The computer-implemented method described herein involves a plurality of processing steps (described in detail below), and is implemented by the at least one processor, for effectively correcting colour reproduction in camera-captured images. Said correction is performed so that colours in the camera-captured images authentically represent true colours (as they appear to a human eye) in real-world scenes.

The at least two images of the real-world environment are received by the at least one processor, from the at least one camera. The at least one processor is communicably coupled to the at least one camera via a wired communication network and/or a wireless communication network. When capturing the at least two images, the at least one camera uses the at least two camera settings that are different from each other, so that the at least one camera can collect diverse visual data about the real-world environment in the form of the at least two images. This diverse visual data represents variations in lighting and colour reproduction, which are important for accurately identifying and correcting colour inconsistencies caused by the at least one camera's inability to reproduce colours accurately under different conditions. Furthermore, this diverse visual data enables accurate understanding of true colours of any light-emitting element(s) that may be present in the real-world environment, and subsequent correction of any errors in reproducing such true colours.

It will be appreciated that the at least one camera may capture the at least two images in several ways. In an example, the at least two images may be captured sequentially by a single camera. In another example, the at least two images may be captured simultaneously by at least two cameras. In yet another example, the at least two images may be captured sequentially by at least two cameras.

Optionally, the at least two images are transmitted and received in real time, upon being captured by the at least one camera. This may be beneficial in cases where the real-world environment being captured is dynamic (for example, it includes moving objects, changing lighting conditions, or similar), or in live-streaming applications. Real-time capture and transmittal ensure that the at least two images represent a same moment or closely related moments in time, for enabling accurate identification and correction of colour reproduction errors in such cases.

Optionally, a camera setting of the at least one camera comprises at least one of: an exposure setting, a gain setting, a white balance setting, a colour conversion matrix, a focus distance setting, an Image Signal Processing (ISP) setting, an ISP algorithm. The term “camera setting” refers to a parameter which affects how a camera captures image data and/or processes the image data to generate an image. Each of these camera settings directly impacts colour reproduction in the camera-captured images (i.e., the at least two images), since they influence how the at least one camera perceives and processes colours in the real-world environment. Using different camera settings for capturing the at least two images leads to accurate identification of colour inconsistencies that need to be corrected. The following paragraphs briefly discuss how each of these camera settings impacts colour reproduction.

The term “exposure setting” encompasses at least one of: an ISO sensitivity setting, an exposure time setting, and an aperture setting. The exposure setting determines an amount of light that reaches an image sensor of the at least one camera. Overexposure can wash out colours, making them appear less saturated or even white, while underexposure can make colours appear darker and less vibrant.

The “gain setting” is an amplification to be applied to an image signal captured by the image sensor. Higher gain settings can introduce noise, particularly in colour channels, which can distort perceived colours in images.

The “white balance setting” is a parameter that adjusts a colour temperature of an image to ensure that white objects appear neutral (i.e., pure white) under different lighting conditions. Incorrect white balance can cause colour casts, such as making an image appear too blue (or too cool-coloured) or too yellow (or too-warm coloured).

The “colour conversion matrix” maps raw sensor data (in RGB or RAW colour space) to a standard colour space (for example, such as sRGB colour space). Errors or variations in the matrix can result in inaccurate colour representation, such as incorrect hues or saturation levels.

The “focus distance setting” affects a sharpness of an image. Out-of-focus areas can exhibit colour fringing or chromatic aberration, particularly in high-contrast areas.

Optionally, the ISP setting comprises at least one of: a sharpness level, a noise reduction intensity, a colour space setting, a dynamic range setting, a tone-mapping profile, a lens correction setting. The ISP setting controls post-capture image processing, which impacts colour accuracy and dynamic range. Each of these parameters of the ISP setting directly influences the colour reproduction and overall image quality in the camera-captured images. As an example, the colour space setting defines a range of colours (i.e., colour gamut) that the at least one camera can capture and process, and improper colour space setting can lead to oversaturated or undersaturated colours. As another example, the dynamic range setting impacts capturing of colour details in bright and dark regions of the real-world environment. So, limited dynamic range can cause colour clipping in bright regions or loss of detail in dark regions. As yet another example, the tone-mapping profile impacts preservation of colour relationships during dynamic range compression, white point adjustment and colour balance, saturation adjustment, and the like. An improper tone-mapping profile that desaturates bright colours excessively may, for example, cause a bright turquoise light-emitting diode to appear as pale blue in an image.

Optionally, the ISP algorithm comprises at least one of: a demosaicing technique, a chromatic aberration correction technique, a dynamic range compression technique, a lens shading correction technique, a gamma correction technique. The ISP algorithm directly affects how colours are interpreted and displayed in the camera-captured images. Each of these techniques of the ISP algorithm directly influences the colour reproduction and overall image quality in the camera-captured images. As an example, the demosaicing technique impacts reconstruction of a full-colour image from incomplete colour data captured by the image sensor, which uses a colour filter array. When the demosaicing technique is implemented improperly (i.e., wrong technique is selected, wrong parameters are set for the selected technique, or similar), the full-colour image has artifacts and does not represent true colours of the real-world environment. As another example, the gamma correction technique impacts how brightness levels of an image are adjusted non-linearly. Improper implementation of the gamma correction technique can cause issues such as colours appearing to be too bright or too dark, colour imbalance across colour channels, inaccurate midtone colours, improper saturation of colours, and the like.

Now, based on the above discussion regarding camera settings, it will be appreciated that the at least two images would have colour inconsistencies therebetween, since they are captured using different camera settings. These colour inconsistencies are identified accurately by analysing the image properties indicative of the colour reproduction in the at least two images. For such analysis, the image properties of the at least two images are extracted from said images, and are compared across the at least two images. For example, saturation and hue in two images may be analysed to identify a colour inconsistency therebetween, wherein the identified colour inconsistency may be that a red LED appears bright in one image but appears washed-out (or pale) in another image. The analysis of the image properties may be performed by the at least one processor, using one or more of a software algorithm, a trained machine-learning model, a neural network configured for image analysis, and the like. The analysis of the image properties may involve pixel-by-pixel comparisons, block-based analysis, feature-based analysis, or similar.

Optionally, the image properties indicative of the colour reproduction comprise at least one of: colour accuracy, colour gamut, saturation, hue, tone mapping, white balance accuracy, dynamic range, noise in colour channels, chromatic aberration. Each of these image properties is a direct indicator of how colours are reproduced in the at least two images, and contributes towards accurately detecting and quantifying colour inconsistencies between the at least two images. In other words, these image properties provide a comprehensive assessment of colour reproduction inconsistencies across the at least two images. By analysing and comparing these image properties across the at least two images, the computer-implemented method can accurately understand how camera settings impact colour reproduction.

“Colour accuracy” is a measure of how closely the colours in an image match ground truth or expected colours. In this case, the ground truth or expected colours would be pre-known to the at least one processor. Different colour accuracies in the at least two images are indicative of the colour inconsistencies therebetween. “Colour gamut” refers to a range of colours that can be represented in an image. Discrepancies in colour gamut between the at least two images indicate inconsistent handling of colour by the at least one camera. “Saturation” in an image indicates an intensity or vividness of colours in the image. Variations in saturation between the at least two images could signal discrepancies in gain, exposure, or colour processing. “Hue” refers to actual colours (e.g., red, green, blue) and their variation in an image. A shift in hue between the at least two images is a clear sign of inconsistency in colour reproduction therebetween. “Tone mapping” for an image indicates how brightness and contrast are adjusted in an image. Differences in tone mapping across the at least two images can indicate perceptual mismatches/inconsistencies in brightness and colour across the at least two images. “White balance” accuracy in an image is a measure of how accurately colours appear under various lighting conditions. Inconsistent white balance accuracy is indicative of colour casts in one or more images amongst the at least two images. “Dynamic range” in an image is a difference between darkest and brightest parts of the image. Differences in dynamic range between the at least two images affect how colours appear in said images, especially in highlight and shadow areas. “Noise in colour channels” of an image distorts colour representation in said image. A higher noise in colour channels of an image as compared to that of another image indicates that colours are distorted differently and to different extents in said images. “Chromatic aberration” refers to colour fringing or blurring at high-contrast edges due to camera lens imperfections. Differences in chromatic aberration can indicate lens or processing discrepancies, and correspondingly, colour inconsistencies across the at least two images.

Optionally, the computer-implemented method further comprises reprojecting the at least two images to a common projection space, prior to the step of analysing the image properties indicative of colour reproduction in the at least two images. Said reprojecting refers to a process of transforming the at least two images into a unified spatial frame of reference, which is the common projection space. This transformation ensures that the at least two images are properly aligned in terms of their spatial geometry, regardless of differences in the camera settings or perspectives used during their capture. The common projection space may be defined based on a specific geometric model, such as a planar projection, spherical projection, or a 3D coordinate system. Reprojecting the at least two images may involve processing operations such as geometric transformations, warping, resampling of pixel data, and the like, to ensure that corresponding points in the real-world environment are aligned across the at least two images. Performing the step of reprojecting ensures an accurate pixel-by-pixel comparison of the at least two images for accurately and reliably analysing the image properties indicative of colour reproduction in the at least two images.

Optionally, the at least two images represent at least one light-emitting element arranged in the real-world environment, and wherein the method further comprises receiving colour reproduction-impacting information of the at least one light-emitting element, wherein the colour reproduction-impacting information comprises at least one of: spectral characteristics, brightness level information, dynamic operation information, spatial emission characteristics, environmental light context,

and wherein the colour reproduction-impacting information is utilised at the step of analysing the image properties indicative of the colour reproduction in the at least two images.

In this regard, when the at least two images represent the at least one light-emitting element, the colour reproduction-impacting information of the at least one light-emitting element is received to enable an accurate, precise, and context-aware analysis of the colour reproduction in each image amongst the at least two images. By incorporating the colour reproduction-impacting information during the analysis of the image properties, the computer-implemented method ensures that colour inconsistencies in the representation of the at least one light-emitting element are accurately identified. As a result, there is subsequently enabled proper correction of the colour inconsistencies, for achieving improved colour fidelity and realism in the at least one image amongst the at least two images. This embodiment is particularly useful when the real-world environment has complex and/or dynamic lighting conditions.

The “spectral characteristics” of a light-emitting element refer to one or more wavelengths of light emitted by the light-emitting element. The “brightness level information” of a light-emitting element refers to an intensity of light emitted by the light-emitting element. Light-emitting elements may operate across a wide range of brightness levels, from very dim to extremely bright. The “dynamic operation information” of a light-emitting element refers to information about the light-emitting element's operation over time, such as whether the light-emitting is pulsing, flickering, or operating at a constant brightness. The “spatial emission characteristics” of a light-emitting element refers to a spatial distribution of light emitted by the light-emitting element. The spatial distribution may, for example, indicate whether the light-emitting element emits light uniformly or directionally. The “environmental light context” of a light-emitting element refers to information about surrounding lighting conditions of the light-emitting element. For example, the environmental light context could include information about poses of ambient light sources in the real-world environment, ambient light intensity, ambient light colour, light redirection properties of materials in the real-world environment, and similar.

Examples of the at least one light-emitting element include, but are not limited to at least one of a display, a lamp, a fluorescent light, a neon light, a halogen light, a light-emitting diode (LED), an LED strip, a candle, and a natural light source. Notably, colours of the at least one light-emitting element are reproduced differently in the at least two images, since different camera settings are employed for capturing said images.

Next, the information indicative of the identified colour inconsistencies is generated, so that the correction technique (to be subsequently applied) can be determined accurately based on said information. Said information may optionally comprise at least one of: a list of one or more image properties (amongst the image properties that were previously analysed) that are different across the at least two images, values of the one or more image properties, a difference between the values of the one or more image properties. For example, an identified colour inconsistency between two images may be that a green LED appears washed out in a first image amongst the two images but appears vivid (i.e., close to true green) in a second image amongst the two images. The information indicative of this identified colour inconsistency may comprise that ‘Saturation’ is different across the two images, and a value of saturation for pixels representing the green LED is ‘35%’ in the first image and is ‘90%’ in the second image.

Next, the correction technique is determined based on the generated information indicative of the identified colour inconsistencies, and the correction technique is applied to those image(s) amongst the at least two images which actually need correction. For each image that is to be corrected, the correction technique is individually determined based on said image's specific color inconsistencies. In some implementations, the correction technique may be applied on a single image or a subset of images amongst the at least two images. In other implementations, the correction technique may be applied on all images amongst the at least two images. Applying the correction technique on the at least one image minimises processing resource requirements and processing time, which is particularly beneficial when the camera-captured images are to be utilised for real-time applications, when the system is hardware-constrained.

The term “corrected image” refers to an image where colours are reproduced such that they are accurate and realistic. In any corrected image, subtle variations or errors due to lighting conditions or camera settings are minimal or nil. The at least one corrected image represents colours as would be seen by a human eye. When the at least one image optionally represents the at least one light-emitting element, upon applying the correction technique, colours of the at least one light-emitting element are reproduced realistically in the at least one corrected image.

Optionally, the correction technique comprises at least one colour correction adjustment. Optionally, in this regard, the at least one colour correction adjustment comprises at least one of: histogram equalisation, white balance correction, gamma correction, colour space conversion, colour space adjustment, tone mapping, chromatic aberration correction, colour grading and adjustment, lens shading correction, noise reduction in colour channels, colour matching, adaptive colour correction for image portions based on surrounding context.

Optionally, the step of applying the correction technique comprises employing at least one of:
an image correction algorithm,
a model trained at least for colour correction,
a neural network trained at least for colour correction,
for adjusting colour reproduction of the at least one image.

In this regard, employing at least one of the aforesaid advanced correction mechanisms ensures precise colour correction in the at least one image to effectively rectify the identified colour inconsistencies. By such precise colour correction, colour reproduction in the at least one image is improved to closely match real-world colours observable by a human eye. Such correction mechanisms are reliably usable for ensuring consistent and realistic colour reproduction in camera-captured images. Furthermore, such correction mechanisms are faster and more accurate as compared to manual or semi-manual correction mechanisms. Moreover, any one or a combination of the aforesaid advanced correction mechanisms can be easily employed according to a configuration of the system.

It will be appreciated that the image correction algorithm can be a pixel-based algorithm or a block-based algorithm. The image correction algorithm may apply the correction technique on a portion of the at least one image or on an entirety of the at least one image. The image correction algorithm provides a deterministic correction mechanism which applies the correction technique based on predefined logic (for example, predefined rules and/or transformations).

Optionally, the model may be a machine learning-based model. Optionally, the neural network is at least one of: a convolutional neural network (CNN), a Residual Network (ResNet), a You Only Look Once (YOLO)-based neural network. Furthermore, optionally employing the trained model and/or the trained neural network for applying the correction technique enables the computer-implemented method to adapt to dynamic and complex real-world environments, where static correction solutions may not be usable or may provide limited correction. The trained model and/or the trained neural network can optionally also analyse spatial and contextual information in images, for realistically applying the correction technique on requisite pixels of the at least one image. The training process for the model and/or the neural network are discussed in more detail below.

In an embodiment, the computer-implemented method further comprises training the model using a training dataset comprising erroneous images captured by one or more cameras having colour reproduction issues, the erroneous images being captured using a plurality of camera settings, and ground truth images corresponding to the erroneous images, wherein said training comprises employing a supervised learning technique for determining one or more colour correction adjustments, which when applied to the erroneous images, produce colour reproduction consistent with their corresponding ground truth images.

In this regard, the model learns to accurately identify inaccuracies in the erroneous images and precisely determine which colour correction adjustment(s) to apply to the erroneous images (by the correction technique), to make the erroneous images match their corresponding ground truth images. The supervised learning technique enables this learning. Therefore, upon training, when the model is provided a new erroneous image (i.e., an erroneous image which was not a part of the training dataset), the trained model correctly applies requisite colour correction adjustments for adjusting colour reproduction in the at least one image. In this regard, the at least one image amongst the at least two images serves as this at least one new erroneous image.

Optionally, the training dataset further comprises colour context data for pixels in the erroneous images, the colour context data comprising colour information of neighbouring pixels of one or more pixels in the erroneous images, and distances of the neighbouring pixels from the one or more pixels, and wherein said training further comprises employing the colour context data for determining the one or more colour correction adjustments.

In this regard, the term “colour context data” of a pixel in an image refers to data about colour characteristics of surrounding pixels of said pixel. This data provides spatial and contextual relationships between the pixels in the image, which are beneficial for understanding how colours interact and appear in a scene represented in the image. The colour context data goes beyond a colour value of an individual pixel by incorporating the broader context of its environment. The colour information of neighbouring pixels of one or more pixels in the erroneous images may be expressed as colour space values of the neighbouring pixels. The distances of the neighbouring pixels from the one or more pixels could be measured in terms of pixel coordinates or relative positions in the erroneous images. Said colour information and said distances may be utilised during training to accurately learn how the colour information of neighbouring pixels impacts colours of the one or more pixels in a spatial context, and to more precisely determine which colour correction adjustment(s) to apply to the erroneous images, for making the erroneous images match their corresponding ground truth images.

Optionally, the colour context data further comprises at least one of: brightness levels of the neighbouring pixels, information of an edge or a gradient in the neighbouring pixels, environmental lighting context of the neighbouring pixels. As an example, presence of a sharp gradient in the neighbouring pixels may indicate a boundary between different coloured objects in an image.

A technical effect of the considering the colour context data during model training is that it introduces colour-spatial awareness in the model, enabling precise and natural colour corrections in the at least one image. In other words, the colour context data enables the model to learn to recognise how colours of neighbouring pixels of any pixel influence a target colour of said pixel. As a result, there a significant improvement in colour fidelity and reduction of artifacts is produced. This feature enhances the model's performance and applicability across diverse real-world scenarios.

In another embodiment, the computer-implemented method further comprises training the neural network at least for colour correction, wherein upon training, the neural network implements the step of applying the correction technique by:
identifying a set of features in the at least one image which impact colour reproduction;
reducing a spatial dimension of the at least one image while retaining one or more features amongst the set of features in the at least one image, the one or more features having a high impact on the colour reproduction;
processing the one or more features for learning spatial and contextual relationships therebetween and how said relationships impact the colour reproduction; and
applying one or more corrections that improve the colour reproduction, based on said relationships and their impact on the colour reproduction.

In this regard, the neural network could be trained using either a supervised learning technique or an unsupervised learning technique, or a combination thereof. Optionally, the features of the set comprise at least one of: a feature representing an object of interest or its portion, a feature representing spatial relationships, a feature representing environmental light context, a feature representing spectral characteristics. Each of these types of features impacts colour reproduction in the camera-captured images. The object of interest could be a light-emitting element, a user-interaction object, a target object, or similar. For example, the real-world environment may be a cockpit simulator, wherein features representing a display and an equipment (such as an altimeter) may belong to the set of features.

Furthermore, the phrase “reducing the spatial dimension” refers to reducing a two-dimensional spatial representation of the at least one image (i.e., reducing a height and/or a width of the at least one image in terms of pixels). Optionally, the spatial dimension of the at least one image is reduced by employing at least one of: convolutional layers, pooling layers, strides, in the neural network. Said reduction allows the neural network to focus on patterns of colour reproduction and spatial-geometric features to retain only those one or more features which are critical for understanding colour discrepancies, instead of processing every pixel individually. Said reduction may be performed for achieving computational efficiency improvement, and for removing redundant features for improvement of processing accuracy. Next, by optionally learning the spatial and contextual relationships between the one or more features and how said relationships impact the colour reproduction, the trained neural network accurately determines the one or more corrections which improve the colour reproduction in the at least one image. The at least one corrected image generated upon applying the one or more corrections to the at least one image, have improved colour fidelity as compared to the at least one image.

Optionally, the model and/or the neural network can also be employed for analysing the image properties indicative of the colour reproduction in the at least two images. Furthermore, the model and/or the neural network can also be employed for implementing other functionalities. Such implementations enable effective usage of complex specialised processing resources like the model and/or the neural network, for multiple processing tasks.

The present disclosure also relates to the system as described above. Various embodiments and variants disclosed above, with respect to the aforementioned computer-implemented method, apply mutatis mutandis to the system.

Optionally, the system comprises a data repository communicably coupled to the at least one processor, wherein the at least one processor is further configured to store, at the data repository, at least the information indicative of the identified colour inconsistencies and the correction technique applied based on said information. Said information may beneficially be stored at the data repository so that it may be easily utilised during subsequent implementations of the computer-implemented method, for enabling accurate determination of a requisite correction technique to be applied corresponding to subsequently-identified colour inconsistencies. As an example, said information may be utilised for determining the one or more colour correction adjustments in the image correction algorithm. As another example, said information may be included in the training dataset which is used for further training of the model to improve model accuracy. The data repository may be implemented as a memory of a device in which the at least one processor is arranged, a cloud-based memory, or similar.

Optionally, in the system, the at least one camera is arranged on at least one of: an extended-reality (XR) device, a teleport device. In this regard, the at least one camera is a part of a video see-through (VST) system of the XR device and/or the teleport device. The term “extended-reality” encompasses virtual-reality (VR), augmented-reality (AR), mixed-reality (MR), and the like. The XR device may be worn by a user on their head while in operation. The teleport device may be a device which enables users to remotely view the real-world environment from another environment. The teleport device may be an imaging device or a device comprising an imaging device (such as a drone, a robot, or similar). A technical effect of such an arrangement of the at least one camera is that both the XR device and/or the teleport device can be used for real-time imaging-based applications, whilst incorporating correction for colour reproduction in camera-captured images, for such applications. This enables the XR device and/or the teleport device to provide high-quality visual experiences with high colour fidelity.

Optionally, in the system, the at least one processor is arranged in at least one of: an extended-reality (XR) device, a computational device associated with the XR device, a teleport device, a cloud server. Such possible arrangements of the at least one processor are easy to implement, and allow for the system to be utilised in a wide variety of applications. The computational device associated with the XR may be a desktop computer, a laptop computer, a tablet computer, a smartphone, a console, or similar.

### DETAILED DESCRIPTION OF THE DRAWINGS

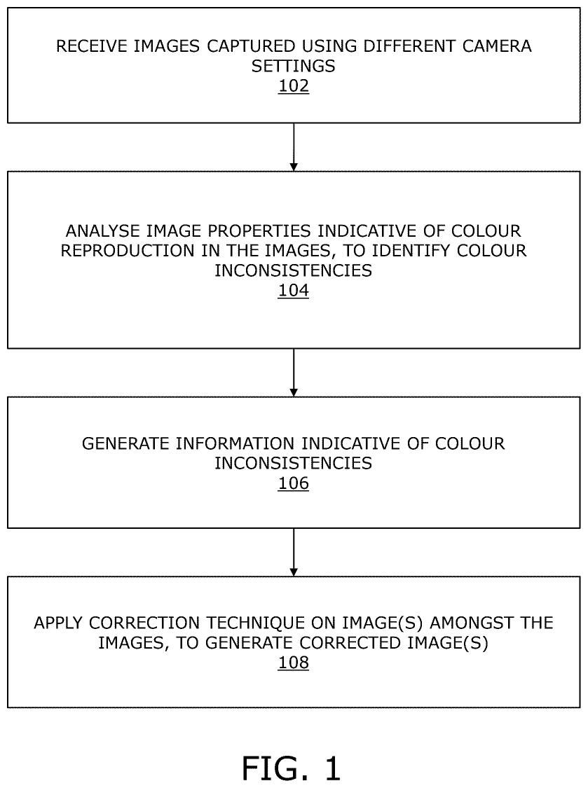

Referring to FIG. 1, illustrated are steps of a computer-implemented method for correcting colour reproduction in camera-captured images, in accordance with an embodiment of the present disclosure. At step 102, at least two images of a real-world environment are received, wherein the at least two images are captured by at least one camera using at least two camera settings that are different from each other. At step 104, image properties indicative of colour reproduction in the at least two images are analysed for identifying colour inconsistencies therebetween. At step 106, information indicative of the identified colour inconsistencies is generated. At step 108, a correction technique is applied on at least one image amongst the at least two images for generating at least one corrected image, based on the generated information indicative of the identified colour inconsistencies.

The aforementioned steps are only illustrative and other alternatives can also be provided where one or more steps are added, one or more steps are removed, or one or more steps are provided in a different sequence without departing from the scope of the claims herein.

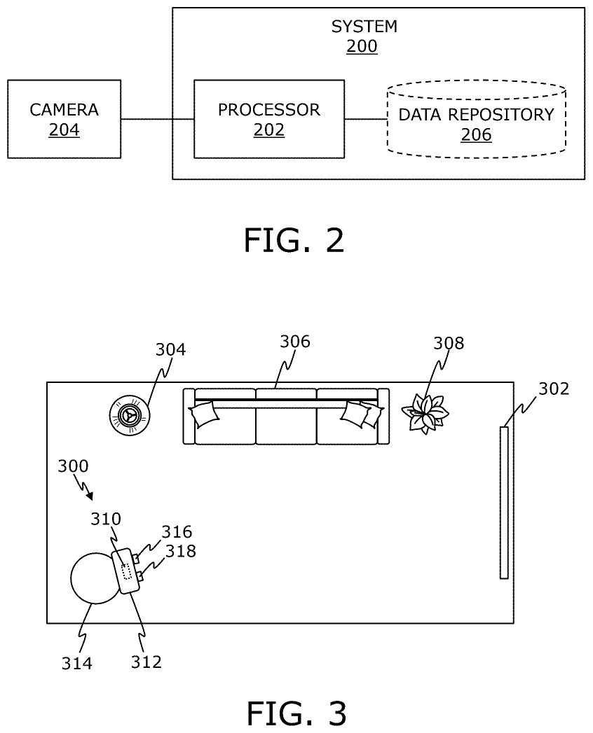

Referring to FIG. 2, illustrated is a block diagram of system 200 for correcting colour reproduction in camera-captured images, in accordance with an embodiment of the present disclosure. The system 200 comprises at least one processor (depicted as a processor 202). The processor 202 is communicably coupled to at least one camera (depicted as a camera 204). The processor 202 is configured to perform various processing operations, as described earlier with respect to the aforementioned first aspect. Optionally, the system 200 further comprises a data repository 206 communicably coupled to the processor 202.

FIG. 2 is merely an example, which should not unduly limit the scope of the claims herein. A person skilled in the art will recognise many variations, alternatives, and modifications of embodiments of the present disclosure.

Referring to FIG. 3, illustrated is an exemplary schematic illustration of a real-world environment where a system 300 for correcting colour reproduction in camera-captured images is used, in accordance with an embodiment of the present disclosure. The real-world environment is shown, for example, as an indoor environment (such as a living room of a house). In this regard, the real-world environment has arranged therein light-emitting elements 302 and 304, as well as non-light-emitting elements 306 and 308. The light-emitting element 302 is a display of a television whereas the light-emitting element 304 is a lamp. The system 300 comprises at least one processor (depicted as a processor 310). The processor 310 is arranged in an extended-reality (XR) device 312 worn by a user on the user's head 314. The processor 310 is communicably coupled to at least one camera (depicted as cameras 316 and 318) arranged to capture images of the real-world environment. In this example, the cameras 316 and 318 are also shown to be arranged on the XR device 312.

FIG. 3 is merely an example, which should not unduly limit the scope of the claims herein. A person skilled in the art will recognise many variations, alternatives, and modifications of embodiments of the present disclosure. As an example, the processor 310 may be arranged in a computational device (not shown) associated with the XR device 312.

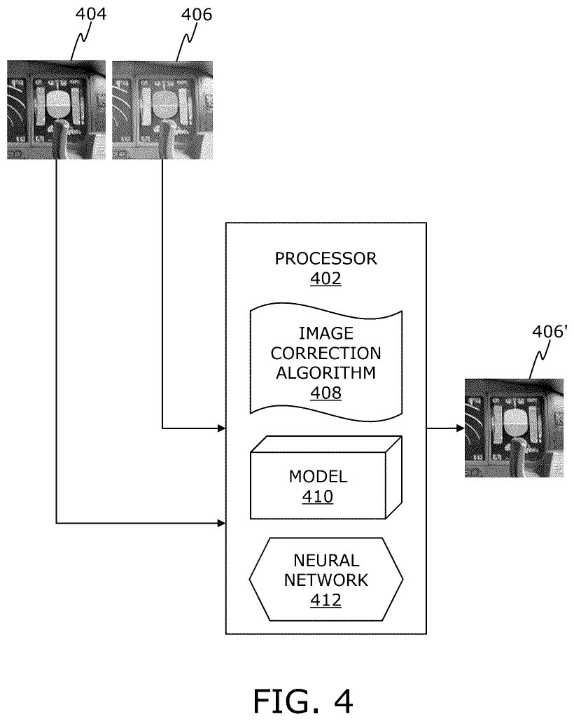

Referring to FIG. 4, is an exemplary illustration of how a correction technique is applied for correcting colour reproduction, in accordance with an embodiment of the present disclosure. A processor 402 receives at least two images (depicted as images 404 and 406) of a real-world environment, wherein the images 404 and 406 are captured by at least one camera using at least two camera settings that are different from each other. Next, the processor 402 analyses image properties indicative of colour reproduction in the at least two images for identifying colour inconsistencies therebetween, and generates information indicative of the identified colour inconsistencies. Then, the processor 402 applies a correction technique on at least one image (for example, such as the image 406) amongst the images 404 and 406, to generate at least one corrected image (depicted as the corrected image 406′). The correction technique is applied based on the generated information indicative of the identified colour inconsistencies. When applying the correction technique, the processor 402 employs at least one of: an image correction algorithm 408, a model 410 trained at least for colour correction, a neural network 412 trained at least for colour correction, for adjusting colour reproduction of the image 406.

1. A computer-implemented method for correcting colour reproduction in camera-captured images, the method comprising:
receiving at least two images of a real-world environment, wherein the at least two images are captured by at least one camera using at least two camera settings that are different from each other;
analysing image properties indicative of colour reproduction in the at least two images for identifying colour inconsistencies therebetween;
generating information indicative of the identified colour inconsistencies; and
applying a correction technique on at least one image amongst the at least two images for generating at least one corrected image, based on the generated information indicative of the identified colour inconsistencies.

2. The computer-implemented method of claim 1, wherein a camera setting of the at least one camera comprises at least one of: an exposure setting, a gain setting, a white balance setting, a color conversion matrix, a focus distance setting, an Image Signal Processing (ISP) setting, an ISP algorithm.

3. The computer-implemented method of claim 2, wherein the ISP setting comprises at least one of: a sharpness level, a noise reduction intensity, a colour space setting, a dynamic range setting, a tone-mapping profile, a lens correction setting.

4. The computer-implemented method of claim 2, wherein the ISP algorithm comprises at least one of: a demosaicing technique, a chromatic aberration correction technique, a dynamic range compression technique, a lens shading correction technique, a gamma correction technique.

5. The computer-implemented method of claim 1, wherein the image properties indicative of the colour reproduction comprise at least one of: colour accuracy, color gamut, saturation, hue, tone mapping, white balance accuracy, dynamic range, noise in colour channels, chromatic aberration.

6. The computer-implemented method of claim 1, further comprising reprojecting the at least two images to a common projection space, prior to the step of analysing the image properties indicative of colour reproduction in the at least two images.

7. The computer-implemented method of claim 1, wherein the step of applying the correction technique comprises employing at least one of:
an image correction algorithm,
a model trained at least for colour correction,
a neural network trained at least for colour correction,
for adjusting colour reproduction of the at least one image.

8. The computer-implemented method of claim 7, further comprising training the model using a training dataset comprising
erroneous images captured by one or more cameras having colour reproduction issues, the erroneous images being captured using a plurality of camera settings, and
ground truth images corresponding to the erroneous images,
wherein said training comprises employing a supervised learning technique for determining one or more colour correction adjustments, which when applied to the erroneous images, produce colour reproduction consistent with their corresponding ground truth images.

9. The computer-implemented method of claim 8, wherein the training dataset further comprises colour context data for pixels in the erroneous images, the colour context data comprising colour information of neighbouring pixels of one or more pixels in the erroneous images, and distances of the neighbouring pixels from the one or more pixels, and wherein said training further comprises employing the colour context data for determining the one or more colour correction adjustments.

10. The computer-implemented method of claim 7, further comprising training the neural network at least for colour correction, wherein upon training, the neural network implements the step of applying the correction technique by:
identifying a set of features in the at least one image which impact colour reproduction;
reducing a spatial dimension of the at least one image while retaining one or more features amongst the set of features in the at least one image, the one or more features having a high impact on the colour reproduction;
processing the one or more features for learning spatial and contextual relationships therebetween and how said relationships impact the colour reproduction; and
applying one or more corrections that improve the color reproduction, based on said relationships and their impact on the colour reproduction.

11. The computer-implemented method of claim 1, wherein the at least two images represent at least one light-emitting element arranged in the real-world environment, and wherein the method further comprises receiving colour reproduction-impacting information of the at least one light-emitting element, wherein the colour reproduction-impacting information comprises at least one of: spectral characteristics, brightness level information, dynamic operation information, spatial emission characteristics, environmental light context,
and wherein the colour reproduction-impacting information is utilised at the step of analysing the image properties indicative of the colour reproduction in the at least two images.

12. A system for correcting colour reproduction in camera-captured images, the system comprising at least one processor configured to:
receive at least two images of a real-world environment from at least one camera, wherein the at least two images are captured by the at least one camera using at least two camera settings that are different from each other, the at least one camera being communicably coupled to the at least one processor;
analyse image properties indicative of colour reproduction in the at least two images to identify colour inconsistencies therebetween;
generate information indicative of the identified colour inconsistencies; and
apply a correction technique on at least one image amongst the at least two images to generate at least one corrected image, based on the generated information indicative of the identified colour inconsistencies.

13. The system of claim 12, further comprising a data repository communicably coupled to the at least one processor, wherein the at least one processor is further configured to store, at the data repository, at least the information indicative of the identified colour inconsistencies and the correction technique applied based on said information.

14. The system of claim 12, wherein the at least one camera is arranged on at least one of: an extended-reality (XR) device, a teleport device.

15. The system of claim 12, wherein the at least one processor is arranged in at least one of: an extended-reality (XR) device, a computational device associated with the XR device, a teleport device, a cloud server.

16. A computer program product comprising a non-transitory machine-readable data storage medium having stored thereon program instructions that, when executed by at least one processor, cause the at least one processor to implement steps of the computer-implemented method of claim 1.
